(19) United States
(12) Patent Application Publication
(10) Pub. No.: US 2005/0265333 A1
(43) Pub. Date: Dec. 1, 2005

(54) Method for enabling efficient multicast transmission in a packet-based network

(75) Inventors: John T. Coffey, San Francisco, CA (US); Richard G. C. Williams, Santa Rosa, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/047,192

(22) Filed: Jan. 31, 2005

Related U.S. Application Data
(60) Provisional application No. 60/576,018, filed on Jun. 1, 2004.

(51) Int. Cl. H04L 12/56

(52) U.S. Cl. 370/389

(57) ABSTRACT

A communication receiver 52 is disclosed, the receiver operable to receive packets 150, each packet comprising at least a header field 152, a plurality of overhead fields 154, and a plurality of data fields 156, with the overhead fields 154 received contiguous in time to each other and the data fields 156 received contiguous in time to each other and after the overhead fields 154.

### CROSS-REFERENCE TO RELATED APPLICATIONS

This application claims priority to U.S. Provisional Application No. 60/576,018 filed Jun. 1, 2004, and entitled “Method for enabling efficient multicast transmission in a packet-based network,” by John T. Coffey et al, incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to communication devices, and more particularly, but not by way of limitation, to a method for enabling efficient multicast transmission in a packet-based network.

### BACKGROUND OF THE INVENTION

Communications traffic may be structured as packets containing digital information about the communication means as well as the information content. The purpose of the communication is to convey the information content from one point to another, and the information about the communication means may be considered to be an administrative or a management cost of the communication. This administrative or management cost of communication may be referred to as communications overhead or overhead. The packets may be transmitted to a plurality of receivers, for example a plurality of computer systems on a local area network or a plurality of wireless receivers in a wireless local area network. Each receiver may decode the packets to determine if the packet is addressed to that receiver.

Packet based communication may employ packets with structures or fields within the packets. For example, a packet may comprise a header field that contains information about the communication means followed by a data field. In some cases, multiple separate messages may be encapsulated in a single packet, perhaps to reduce the communications overhead. A packet encapsulating multiple separate messages may include a header field followed by multiple overhead and content fields. The overhead fields may also be referred to as signal fields. The header field may contain information about the communication means that applies to the entire packet while each overhead field may contain information about the communication means of one specific content field associated with that specific overhead field.

### SUMMARY OF THE INVENTION

A communication receiver is disclosed, the receiver operable to receive packets, each packet comprising at least a header field, a plurality of overhead fields, and a plurality of data fields, with the overhead fields received contiguous in time to each other and the data fields received contiguous in time to each other and after the overhead fields.

A communication transmitter is disclosed, the transmitter operable to transmit packets, each packet comprising at least a plurality of overhead fields and a plurality of data fields, with the overhead fields transmitted contiguous in time to each other and the data fields transmitted after the overhead fields and contiguous in time to each other.

A method for receiving wireless messages is disclosed. The method comprises decoding a plurality of overhead fields of a first multicast packet, the overhead fields received contiguous in time, at least some of the overhead fields including wireless capability information. The method further includes deciding, based on at least some of the overhead fields, to decode at least some of the additional fields of the first multicast packet, the at least some of the additional fields received contiguous in time and decoding a plurality of overhead fields of a second multicast packet, the overhead fields received contiguous in time, at least some of the overhead fields including wireless capability information; and deciding, based on at least some of the overhead fields, to omit decoding at least some of the additional fields of the second multicast packet.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram of a local area network and a wireless local area network according to an embodiment of the disclosure.

FIG. 2 is a block diagram of a communication device according to an embodiment of the disclosure.

FIG. 3 is an illustration of a communication packet structure according to an embodiment of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

A packet that encapsulates multiple separate messages may be structured into fields including a first header field followed by a sequence of overhead fields contiguous with associated data fields. For example, a packet may comprise a header field followed by a first overhead field describing a first data field. The first overhead field may be followed by the first data field, and the first data field may be followed by a second overhead field describing a second data field. The second overhead field may be followed by a second data field, and the second data field may be followed by a third overhead field describing a third data field. This structure allows each overhead field and associated data field to be self-contained and independent, and allows the overhead field and data field pairs to be appended to the end of the packet arbitrarily. For example, a transmitter could begin transmitting a packet, then receive a message which the transmitter formats as an overhead field and data field pair, and then opportunistically append the overhead field and data field to the packet.

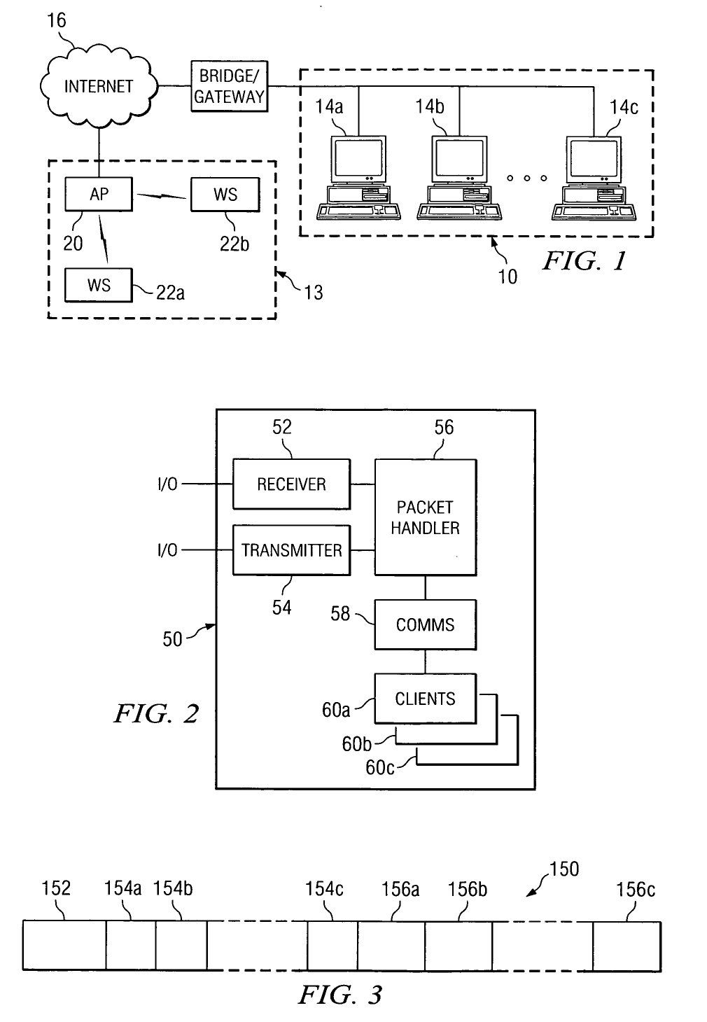

Turning now to FIG. 1, a block diagram of a local area network (LAN) 10 and a wireless local area network (WLAN) 12 are depicted that are conformable to the several embodiments of the present disclosure. The LAN 10 may comprise a plurality of computers 14, for example personal computers, that communicate with each other via a communication cable. The plurality of computers 14 may include a first computer 14a, a second computer 14b, and a third computer 14c. The LAN 10 may communicate with the Internet 16 via a bridge and/or gateway device 18. The WLAN 12 may comprise an access point 20 and a plurality of wireless stations 22, including a first wireless station 22a and a second wireless station 22b, that communicate with each other via the access point 20. The communications among the computers 14 on the LAN 10 may be structured as packets. The communications among the wireless stations 22 and the access point 20 in the WLAN 12 may be structured as packets. The communications between the LAN 10 and the internet 16 and between the WLAN 12 and the internet 16 may be structured as packets. In an embodiment, the WLAN 12 conforms to the IEEE-802.11 standard or the IEEE-802.15.3 standard.

Turning now to FIG. 2, a block diagram of a communication device 50 is depicted that may be used to enable communications conformable to the several embodiments of the present disclosure in the computers 14, the access point 20, or the wireless station 22. The communication device 50 comprises a receiver 52 that receives packets and a transmitter 54 that transmits packets respectively. In an embodiment, the receiver 52 and transmitter 54 may be combined in a single transceiver component. A packet handler component 56 provides partial processing of packets that are received and transmitted according to an embodiment of the present disclosure and mediates between a communication component 58 and both the receiver 52 and the transmitter 54. The communication component 58 provides communication services to communication clients 60, including a first communication client 60a, a second communication client 60b, and a third communication client 60c. In an embodiment, there may be fewer or more communication clients. In an embodiment, the packet handler component 56 may be a circuit component, a software or firmware component, or may be integrated into the communications component 58 as a functional element. For example, the packet handler component 56 may be realized in integrated circuits, for example application specific integrated circuits (ASICs), field programmable gate arrays (FPGAs), complex programmable logic devices (CPLDs), portions of digital signal processors, portions of microprocessors, portions of microcontrollers, or other special purpose circuit realizations known to those skilled in the art. The packet handler component 56 may be combined with one or more of the other components described above as a “system on a chip” including the receiver 52, the transmitter 54, the communication component 58, the communication clients 60, one or more antennas (not shown).

Turning now to FIG. 3, an exemplary packet structure 150 according to an embodiment of the present disclosure is depicted. The packet structure 150 encapsulates multiple independent messages. The messages may be encapsulated in a single packet in order to share a single header among multiple messages and hence reduce overhead. The packet structure 150 comprises a header 152, multiple overhead fields 154, and multiple data fields 156. There is a one-to-one association between each overhead field 154 and one specific data field. For example, a first overhead field 154a is associated with a first data field 156a, a second overhead field 154b is associated with a second data field 156b, and a third overhead field 154c is associated with a third data field 156c. Each overhead field 154 contains information about the communication means, for example a data rate, an antenna configuration, and an encoding scheme. The overhead field 154 may also designate a length of and a position offset to locate the data field 156 associated with the overhead field 154.

The packet handler 56 may process the header 152 and the plurality of overhead fields 154, for example the first, second, and third overhead fields 154a, 154b, and 154c before the plurality of data fields 156 are received. In an embodiment, the packet handler 56 may periodically process data fields 156 which conform to a fixed length format, for example embedded voice over Internet protocol (VOIP) packets or moving pictures experts group (MPEG) packets. When processing fixed length format data fields, the transmitter 54 may process and begin transmitting the header 152 and the plurality of overhead fields 154 before receiving the data itself. The packet handler 56 may determine that the receiver 52 is not capable of receiving the first data field 156a and the second data field 156b and place the receiver 52 in power saving mode, for example a sleep mode, during the time that the first data field 156a and the second data field 156b are present on the inputs of the receiver 52 and placing the receiver 52 back into receiving mode during the time the third data field 156c is present on the inputs of the receiver 52. In this way the receiver 52 may conserve power which may be useful for devices operating on battery power, for example wireless stations 22 such as a laptop computer. The receiver 52 may not be capable of receiving a transmitted data field 156, for example because the data field 156 is transmitted with multiple antennas in a multiple input multiple output mode and the receiver 52 is coupled to only one antenna and is incapable of receiving multiple input multiple output mode messages.

In an embodiment, a robust error detection/correction method may be applied to the overhead fields 154 of the packet structure 150. The robust error detection/correction method may be more efficient when the overhead fields 154 are contiguous, as in the several embodiments of the present disclosure, than if the overhead fields 154 were intermixed with data fields 156.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

1. A communication device, comprising:
a receiver operable to receive packets, each packet comprising at least a header field, a plurality of overhead fields, and a plurality of data fields, the overhead fields received contiguous in time to each other, the data fields received contiguous in time to each other and after the overhead fields.

2. The communication device of claim 1, wherein the number of overhead fields is equal to the number of data fields, the overhead fields contain an information about the encoding of the data fields, and the receiver is operable to omit decoding the data fields which the receiver determines, based on the information about the encoding, that the receiver declines to decode.

3. The communication device of claim 2, wherein the receiver conserves energy when it does not decode the data fields.

4. The communication device of claim 1, wherein the data fields contain media access control address information.

5. The communication device of claim 1, wherein the overhead fields contain media access control address information.

6. A communication device, comprising:
a transmitter operable to transmit packets, each packet comprises at least a plurality of overhead fields and a plurality of data fields, the overhead fields transmitted contiguous in time to each other, the data fields transmitted after the overhead fields and contiguous in time to each other.

7. The communication device of claim 6, wherein the number of overhead fields is equal to the number of data fields and wherein each overhead field contains an information about one of the data fields.

8. The communication device of claim 7, wherein the information about one of the data fields defines an antenna configuration.

9. The communication device of claim 7, wherein the information about one of the data fields defines a length of the data field.

10. The communication device of claim 7, wherein the information about one of the data fields defines a data rate.

11. The communication device of claim 7, wherein the information about one of the data fields defines a position offset.

12. The communication device of claim 6, wherein each packet further comprises:
a synchronization field operable to promote a receiver determining the structure of the packet;
a training field operable to promote a receiver estimating a communications channel; and
a packet signal field operable to indicate a length of the packet.

13. The communication device of claim 6, wherein the network interface logic transmits the packets in accordance with a wireless communication standard selected from the group consisting of an IEEE-802.11 standard and an IEEE-802.15.3 standard.

14. The communication device of claim 6, wherein at least some of the data fields contain data formatted according to a standard selected from one of a voice over Internet protocol standard and a moving pictures experts group standard and wherein the communication device begins transmitting a packet before all of the data of all of the data fields is available to the communication device.

15. A method for receiving wireless messages, comprising:
decoding a plurality of overhead fields of a first multicast packet, the overhead fields of the first multicast packet received contiguous in time, at least some of the overhead fields including wireless capability information;
deciding, based on at least some of the overhead fields, to decode at least some additional fields of the first multicast packet, the at least some additional fields received contiguous in time;
decoding a plurality of overhead fields of a second multicast packet, the overhead fields of the second multicast packet received contiguous in time, at least some of the overhead fields including wireless capability information; and
deciding, based on at least some of the overhead fields of the second multicast packet, to omit decoding at least some additional fields of the second multicast packet, the at least some additional fields of the second multicast packet received contiguous in time.

16. The method of claim 15, wherein the at least some additional fields of the first multicast packet comprise a plurality of data fields and the at least some of the overhead fields of the first multicast packet define the wireless capabilities used to transmit the data fields and wherein the at least some additional fields of the second multicast packet comprise a plurality of data fields and the at least some of the overhead fields of the second multicast packet define the wireless capabilities used to transmit the data fields.

17. The method of claim 15, wherein the wireless capability information contained in both the first multicast packet and the second multicast packet defines an antenna configuration.

18. The method of claim 15, wherein the wireless capability information contained in both the first multicast packet and the second multicast packet defines a length of the data field.

19. The method of claim 15, wherein the wireless capability information contained in both the first multicast packet and the second multicast packet defines a transmission data rate.

20. The method of claim 15, wherein the wireless capability information contained in both the first multicast packet and the second multicast packet defines a position offset.
